(19) United States
(12) Patent Application Publication
(10) Pub. No.: US 2014/0174220 A1
(43) Pub. Date: Jun. 26, 2014

(54) ACTUATOR FOR ACTIVE AIR FLAP APPARATUS

(71) Applicants: Hyundai Motor Company, Seoul (KR); Hyundai Mobis Co., Ltd., Seoul (KR); Kia Motors Corporation, Seoul (KR)

(72) Inventors: Phil Jung Jeong, Yongin (KR); Bock Cheol Lee, Suwon (KR); Dong Eun Cha, Suwon (KR); Hyun Gyung Kim, Hwaseong (KR); Seung Mok Lee, Osan (KR); Young Sub Oh, Suwon (KR); In Cheol Kim, Yongin (KR)

(21) Appl. No.: 13/938,513

(22) Filed: Jul. 10, 2013

(30) Foreign Application Priority Data
Dec. 21, 2012 (KR) 10-2012-0150329

(51) Int. Cl. B60K 11/08; F16H 19/08

(52) U.S. Cl. CPC B60K 11/085; F16H 19/08
USPC 74/89.14

(57) ABSTRACT

Disclosed herein is an actuator for an active air flap apparatus which may manually open air flaps during an actuator failure and may prevent the opened air flaps from closing using e.g., vehicle induced wind. The apparatus includes a worm gear that is driven by the power of a motor and a spur gear that is configured to transmit rotary force of the worm gear towards the air flaps.

### CROSS-REFERENCE TO RELATED APPLICATION

This application claims under 35 U.S.C. §119(a) the benefit of Korean Patent Application No. 10-2012-0150329 filed on Dec. 21, 2012 the entire contents of which are incorporated herein by reference.

### BACKGROUND OF THE INVENTION

1. Field of the Invention

The present invention relates, in general, to an actuator for an active air flap apparatus and, more particularly, to an actuator for an active air flap apparatus which can manually open air flaps during, and can prevent the opened air flaps from being closed again by e.g. vehicle induced wind.

2. Description of the Related Art

Generally, as shown in FIGS. 1 to 3, an air flap apparatus for a vehicle includes a duct housing 1 fixed to a front end module of a vehicle, an actuator 2 fixed to a central portion of the duct housing 1, an H-type guide frame 4 mounted to the duct housing 1 to connect the guide frame 4 to the actuator 2 via an actuator loader 3 to vertically move guide frame 4 using the power of the actuator 2, and air flaps 6 which are rotatably mounted to the duct housing 1 and connected with the guide frame 4 via flap loaders 5.

One side of each air flap 6 is connected to the guide frame 4 via the flap loader 5, and the other side of each air flap 6 is rotatably coupled to the duct housing 1 via a hinge pin 7. The actuator 2 includes a printed circuit board (PCB) 11, a motor 12, a worm gear 13, and a plurality of spur gears 14.

Thus, when the actuator 2 is operated under external conditions (e.g., engine temperature, coolant temperature, etc.), the power of the actuator 2 is transmitted to the guide frame 4 via the actuator loader 3, to vertically move the guide frame 4 to rotate the flap loader 5. Then, when the rotary force of the flap loader 5 is transmitted to the air flaps 6 to rotate the air flaps 6, air vents 1a of the duct housing 1 are opened or closed.

However, in the conventional actuator 2, which uses the worm gear 13 and the spur gears 14, it may be difficult to manually actuate the air flaps 6 when the actuator fails. Further, when the air flaps 6 are closed, temperatures of an engine and other heat exchangers increase, causing potential damage to the vehicle.

In other words, as shown in FIGS. 4 and 5, in the conventional actuator 2 the worm gear has teeth 13a each having opposite faces 13b that protrude at a substantially right angle relative to an axially longitudinal direction of the worm gear 13, and the spur gear has teeth 14a each having opposite faces 14b that protrude at a substantially right angle relative to a tangential direction of the spur gear 14. Thus, the gear teeth 13a and 14a have the friction force F2 greater than the rotary force F1, thus the spur gear 14 may not rotate when the actuator fails, and the air flaps 6, which were connected with the spur gear 14, may not be manually operated.

Specifically, during operation of the conventional actuator 2, when no failure occurs, the worm gear 13 may be rotated by the power of the motor 12 and operates as a driving gear and the spur gear 14 that is connected with the air flaps 6 operates as a driven gear, whereas, when a failure occurs and the air flaps 6 are manually operated, the spur gear 14 operates as the driving gear and the worm gear 13 operates as the driven gear.

In FIG. 5, the reference sign F3 is a component force of the rotary force F1 and the friction force F2, which is applied to the worm gear 13 by the spur gear 14.

The description regarding the related art is provided only for understanding of the background of the invention, so it should not be construed by ordinarily skilled persons in the art to be admitted to be the related art.

### SUMMARY

Accordingly, the present invention provides an actuator for an active air flap apparatus which may manually open air flaps during a failure, and may prevent the opened air flaps from closing by e.g. vehicle-induced wind.

According to one aspect of the present invention, an actuator for an active air flap apparatus, includes: a worm gear driven by the power of a motor; and a spur gear configured to transmit the rotary force of the worm gear towards air flaps, wherein the worm gear has a plurality of teeth each having opposite faces that are asymmetrically inclined at different inclined angles relative to an axially longitudinal direction of the worm gear, and wherein the spur gear has a plurality of teeth engaged with the teeth of the worm gear and each having opposite faces that are asymmetrically inclined at different inclined angles relative to a tangential direction of the spur gear.

The opposite faces of a tooth of the worm gear may have a first face that is inclined at a substantially right inclined angle relative to the axially longitudinal direction of the worm gear, and a second face that has a greater incline than the first face. The opposite faces of a tooth of the spur gear may have first and second faces that are inclined at the same inclined angles as and parallel with the first and second faces, respectively, of the tooth of the worm gear.

Furthermore, when the air flaps rotate to close in a manual operation, the first faces of the teeth of the worm gear and the spur gear come into contact with each other, preventing the air flaps from closing.

According to another embodiment of the present invention, the actuator includes: a worm gear driven by the power of a motor; and a spur gear configured to transmit the rotary force of the worm gear towards air flaps, wherein the worm gear has a plurality of teeth each having opposite faces that are symmetrically inclined at an inclined angle relative to an axially longitudinal direction of the worm gear, wherein the spur gear has a plurality of teeth being engaged with the teeth of the worm gear and each having opposite faces that are symmetrically inclined at the same inclined angle as that of the worm gear, relative to a tangential direction of the spur gear, and wherein a stopper is disposed in an actuator housing and is configured to restrict the worm gear from moving in one direction.

In particular, when the air flaps are actuated to close in a manual operation, the stopper may be brought into contact with the worm gear to restrict the worm gear from moving in one direction.

According to the present invention, an actuator for an active air flap apparatus may manually open air flaps when the actuator fails, and when the air flaps are opened, may prevent the opened air flaps from closing by e.g. vehicle induced wind, thereby further improving operative stability of vehicle parts.

### BRIEF DESCRIPTION OF THE DRAWINGS

The above and other objects, features and advantages of the present invention will be more clearly understood from the following detailed description when taken in conjunction with the accompanying drawings, in which:

FIGS. 1 to 3 are exemplary views showing an air flap apparatus for a vehicle according to the related art;

FIGS. 4 and 5 are exemplary views showing a worm gear and a spur gear of a conventional actuator according to the related art;

FIGS. 6 and 7 are exemplary views showing a worm gear and a spur gear of an actuator for an active air flap apparatus according to an exemplary embodiment of the present invention; and

FIGS. 8 and 9 are exemplary views showing a worm gear, a spur gear and a stopper of an actuator for an active air flap apparatus according to another exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Reference will now be made in greater detail to an exemplary embodiment of the invention, an example of which is illustrated in the accompanying drawings Wherever possible, the same reference numerals will be used throughout the drawings and the description to refer to the same or like parts.

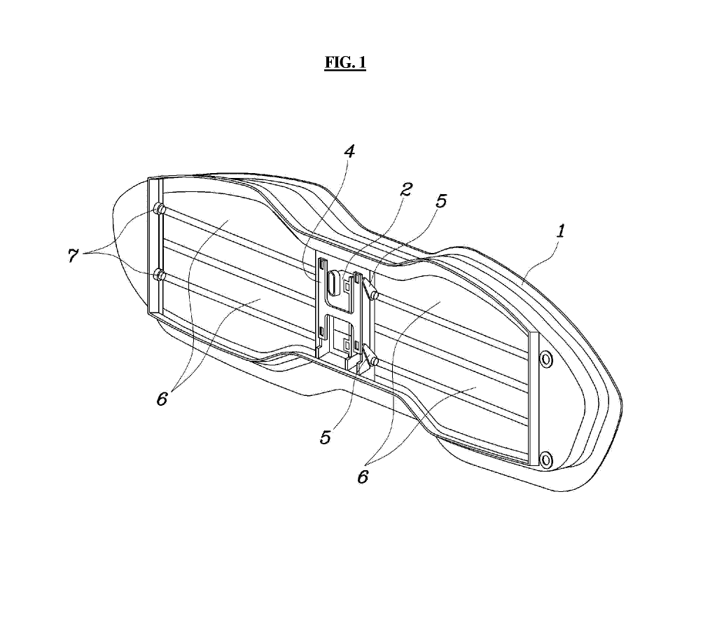

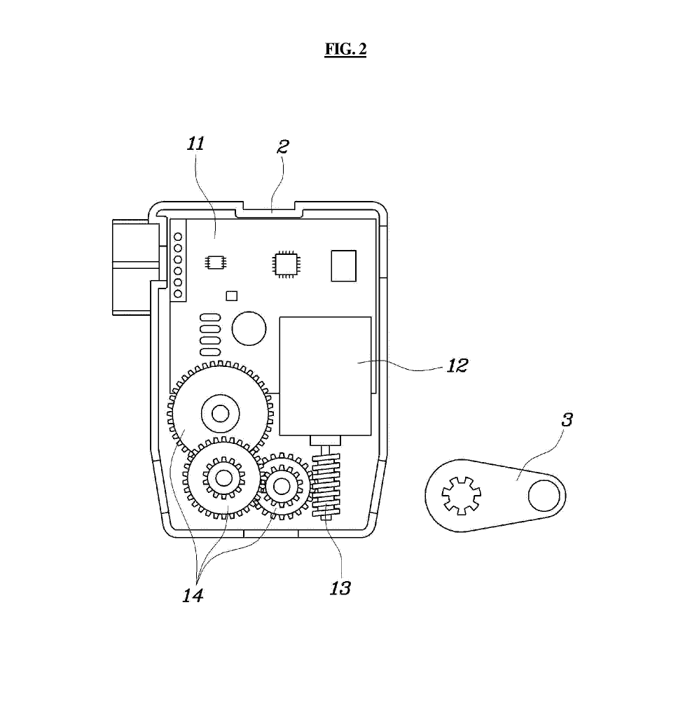

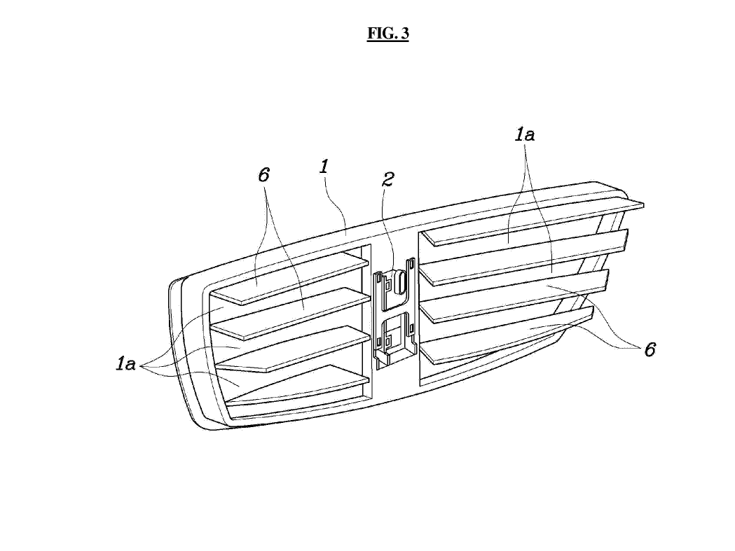

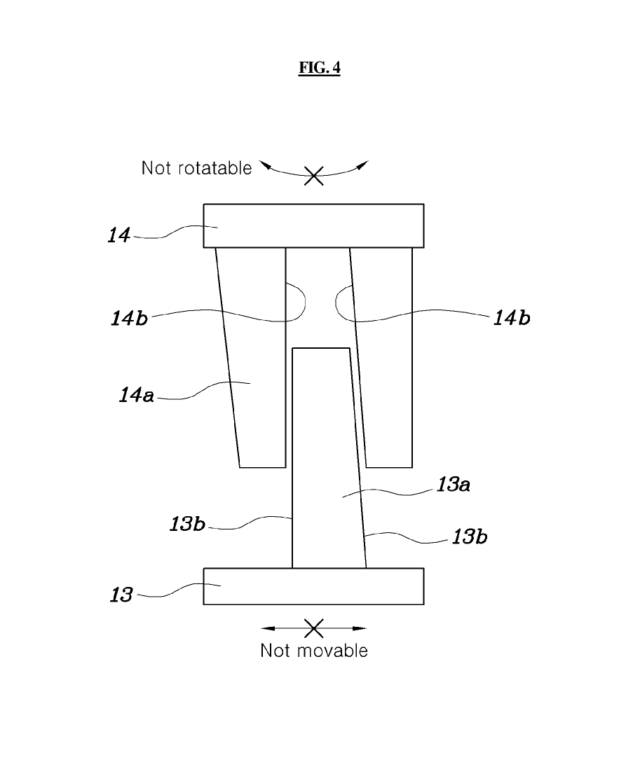

As shown in FIG. 1, an air flap apparatus for a vehicle may include a duct housing 1 fixed to a front end module of a vehicle, an actuator 2 fixed to a central portion of the duct housing 1, an H-type guide frame 4 mounted to the duct housing 1 to connect the guide frame 4 with the actuator 2 via an actuator loader 3 to move the guide frame 4 vertically using the power of the actuator 2, and air flaps 6 rotatably mounted to the duct housing 1 to connect the air flaps 6 with the guide frame 4 via flap loaders 5.

One side of each air flap 6 is connected to the guide frame 4 via the flap loader 5, and the other side of each air flap 6 is rotatably coupled to the duct housing 1 via a hinge pin 7.

The actuator 2 may include a conventional printed circuit board (PCB) 11, a motor 12, a worm gear 13 disposed in the motor 12 to axially rotate the worm gear 13 using the power of the motor 12, and a plurality of spur gears engaged with the worm gear to transmit the power towards the air flaps 6.

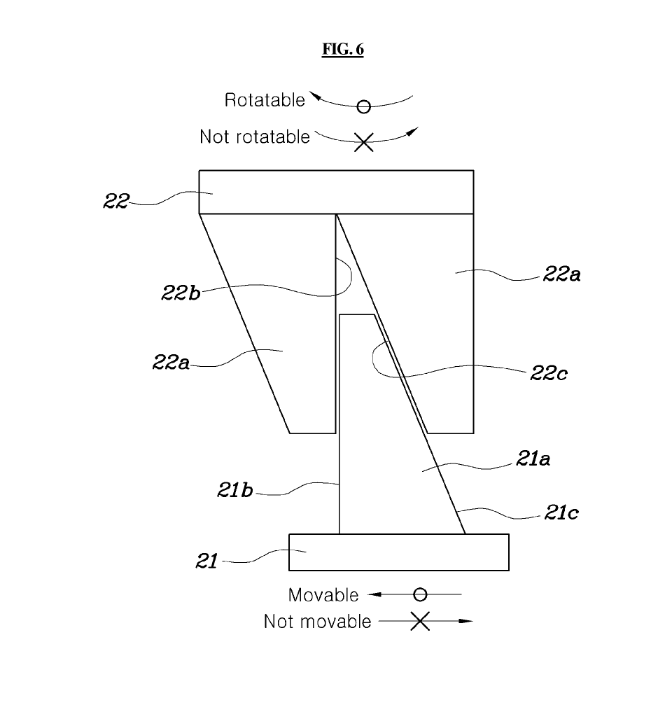

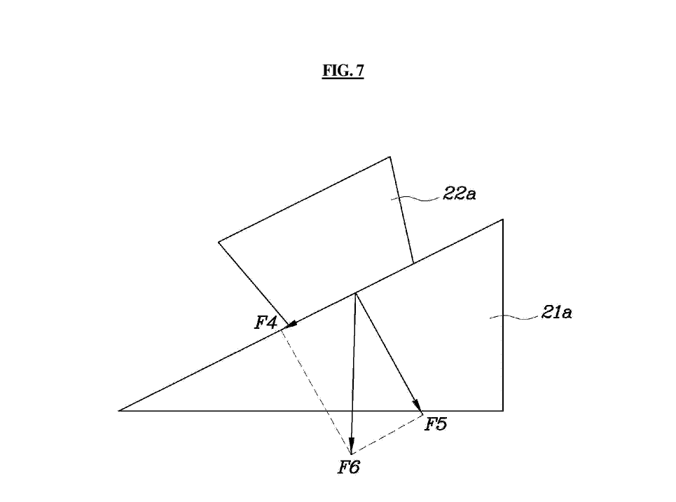

In an exemplary embodiment of the present invention, the worm gear 21 of the actuator 2 may include a spiral tooth 21a as shown in FIGS. 6 and 7, wherein opposite faces of the tooth 21a are asymmetrically inclined at different inclined angles relative to an axially longitudinal direction of the worm gear 21. Further, the opposite faces of a tooth 22a of the spur gear 22, engaged with the opposite faces of the tooth 21a of the worm gear, may be asymmetrically inclined at different angles relative to a tangential direction of the spur gear 22.

In other words, the opposite faces of the tooth 21a of the worm gear may include a first face 21b inclined at a substantially right inclined angle relative to the axially longitudinal direction of the worm gear 21, and a second face 21c having a greater incline than the first face 21b. Further, the opposite faces of the tooth 22a of the spur gear may include first and second faces 22b and 22c inclined at the substantially same inclined angle as and substantially parallel with the first and second faces 21b and 21c, respectively, of the tooth 21a of the worm gear.

In particular, when the air flaps 6 rotate to close in a manual operation, the first faces 21b and 22b of the teeth 21a and 22a of the worm gear and the spur gear come into contact with each other, to prevent the air flaps 6 from closing.

In addition, when failure does not occur and the motor 12 of the actuator 2 is driven, the worm gear may be configured to axially rotate to cause the tooth 21a to transmit the power to the tooth 22a of the spur gear, and rotate the spur gear 22, thereby enabling the air flaps 6 to open and close.

When the actuator fails, the air flaps 6 may be opened manually. Specifically, when the air flaps 6 are manually rotated to be opened, the spur gear 22, connected with the air flaps 6, may be configured to rotate in a clockwise direction as illustrated in FIG. 6, and the worm gear 21 may be configured to substantially smoothly axially rotate. Thus, during a break down the air flaps 6 may be manually opened.

In other words, when the spur gear 22 rotates in a clockwise direction as illustrated in FIG. 6, the second faces 22c and 21c of the teeth 22a and 21a are brought into contact with each other. In particular, since the second faces 21c and 22c have greater inclined angles than the first faces, the rotary force F4 of the spur gear 22 may be greater than the friction force F5 of the spur gear when the spur gear comes into contact with the worm gear 21, causing the spur gear 22 to substantially smoothly rotate and to cause the worm gear 21 to be substantially smoothly rotated, thereby enabling the air flaps 6 to be manually opened even during a failure.

The inclined angle of the second faces 21c and 22c is a reference angle from which the rotary force becomes greater than the friction force. The reference angle may have a range between 10° and 15°, without being limited thereto.

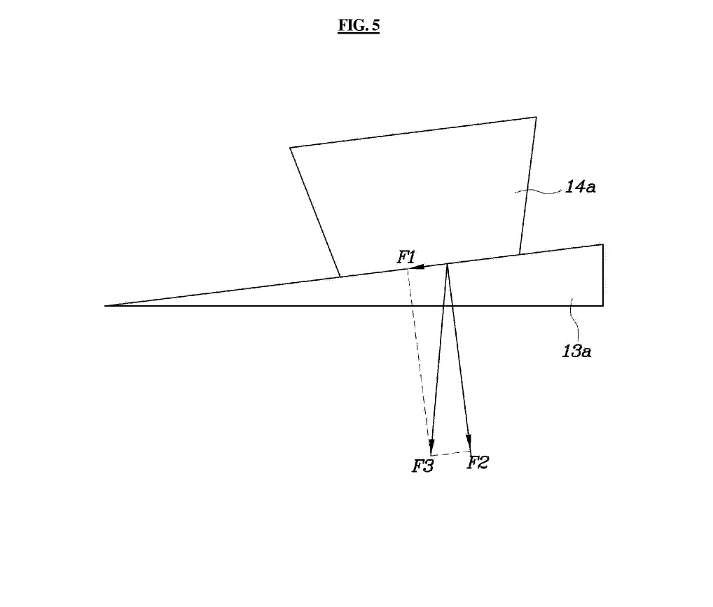

Further, the first faces 21b and 22b may be configured to restrict the air flaps 6, which have been opened in a manual operation, from closing using vehicle induced wind. In other words, since the spur gear 22 may be configured to rotate in a clockwise direction to open the air flaps and rotate in a counterclockwise direction to close the air flaps 6, the spur gear may not be rotated in the counterclockwise direction to restrict the air flaps from closing. In the present embodiment, when the spur gear rotates in the clockwise direction, the first faces 22b and 21b of the teeth 22a and 21a of the spur gear 22 and the worm gear 21 may be brought into contact with each other. In particular, the first faces 21b and 22b may have smaller inclined angles than the second faces, as shown in FIG. 5, to cause the friction force F2 of the spur gear with respect to the worm gear 21 to be greater than the rotary force F1 of the spur gear 22. Therefore, the spur gear 22 may be prevented from rotating, to cause the worm gear 21 from being rotated, thereby preventing the opened air flaps 6 from closing using e.g. vehicle induced wind.

The inclined angle of the first faces 21b and 22b is a reference angle from which the friction force becomes greater than the rotary force. The reference angle may have a range between 2° and 5°, without being limited thereto.

In FIG. 7, the reference sign F6 is a component force of the rotary force F4 and the friction force F5, which is applied to the worm gear 21 by the spur gear 22.

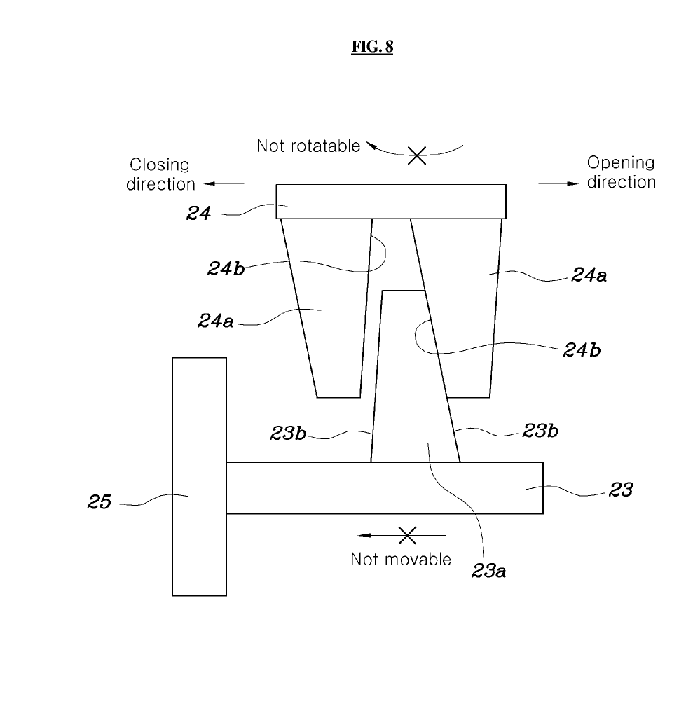

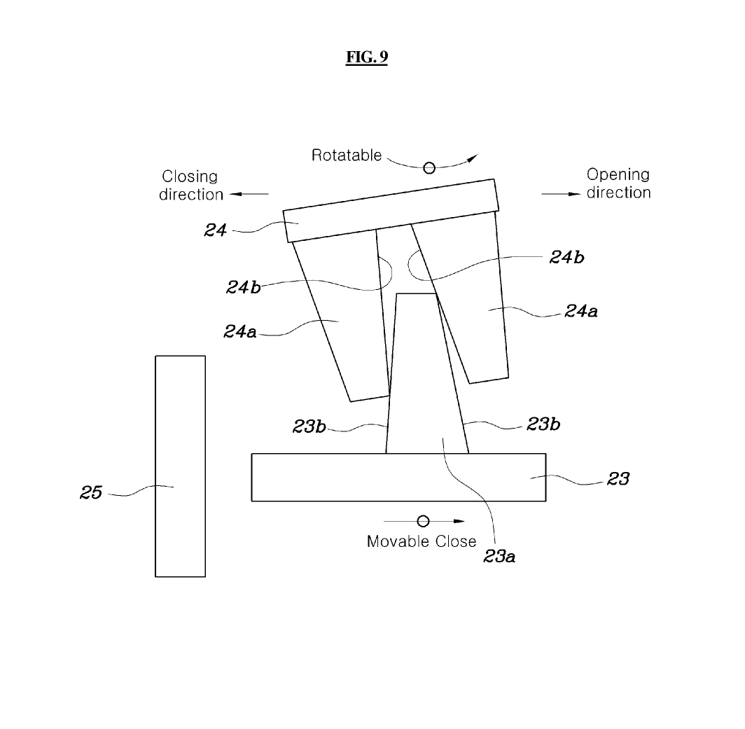

According to another embodiment of the present invention, as shown in FIGS. 8 and 9, an actuator 2 for an active air flap apparatus may include a worm gear 23 driven by the power of a motor, and a spur gear 24 configured to transmit the rotary force of the worm gear towards air flaps, wherein the worm gear 23 has a plurality of teeth 23a each having opposite faces 23b symmetrically inclined at an inclined angle relative to an axially longitudinal direction of the worm gear 23, and the spur gear 24 has a plurality of teeth 24a engaged with the teeth 23a of the worm gear and each having opposite faces 24b symmetrically inclined at substantially the same inclined angle as that 23b of the worm gear, relative to a tangential direction of the spur gear 24.

Further, the actuator 2 may include a stopper 25 disposed in an actuator housing and configured to restrict the worm gear 23 from moving in one direction. In particular, when the air flaps 6 are actuated to be closed in a manual operation, the stopper 25 may be brought into contact with the worm gear 23 to restrict the worm gear 23 from moving in one direction.

When failure does not occur in the actuator 2, as shown in FIG. 8, and the motor 12 of the actuator 2 is driven, the worm gear 23 and the spur gear 24 may be configured to smoothly rotate to open and close the air flaps 6.

When the actuator 2 fails, the air flaps 6 may be opened manually In particular, when the air flaps 6 are configured to be manually rotated to open, the spur gear 24, connected with the air flaps 6, may be configured to rotate and open in a clockwise direction in FIG. 8, and thus the worm gear 23 may move to the right as shown in FIG. 9. Thus, as shown in FIG. 9, the spur gear 24 may be configured to rotate substantially smoothly, together with axial rotation of the worm gear 23, to cause the air flaps 6 to open manually when the actuator 2 fails.

Further, the worm gear 23 and the stopper 25 may be configured to restrict the air flaps 6, which have been opened in a manual operation, from closing using e.g. vehicle-induced wind. In other words, since the spur gear 24 may be configured to rotate in a counterclockwise direction to open the air flaps and may be configured to rotate in a clockwise direction to close the air flaps 6, the spur gear 24 may not be rotated in the clockwise direction to prevent the air flaps 6 from closing. In the exemplary embodiment of the present invention, when the spur gear 24 is configured to rotate in the clockwise direction, the worm gear 23 may be moved to the left as shown in FIG. 9 to cause one end thereof to be brought into contact with the stopper 25 as shown in FIG. 8.

Additionally, since the spur gear 24 may be restricted from rotating in a clockwise direction by the tooth 23a of the worm gear 23, the spur gear 24 and the worm gear 23 may not be rotated together, thus preventing the opened air flaps 6 from closing using e.g. vehicle induced wind.

As described herein, according to the actuator 2 of the present invention, the shape of the teeth of the worm gear and the spur gear may vary, and the stopper may be used in the actuator, to manually open air flaps during an actuator failure, and prevent the opened air flaps from closing use e.g. vehicle induced wind, thereby improving operative stability of vehicle parts.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An actuator for an active air flap apparatus, the actuator comprising:
a worm gear driven by the power of a motor; and
a spur gear configured to transmit rotary force of the worm gear towards a plurality of air flaps,
wherein the worm gear has a plurality of teeth each having opposite faces asymmetrically inclined at different inclined angles relative to an axially longitudinal direction of the worm gear, and
wherein the spur gear has a plurality of teeth engaged with the teeth of the worm gear and each having opposite faces asymmetrically inclined at different inclined angles relative to a tangential direction of the spur gear.

2. The actuator according to claim 1, wherein the opposite faces of each tooth of the worm gear includes a first face inclined at a substantially right inclined angle relative to the axially longitudinal direction of the worm gear, and a second face having a greater incline than the first face.

3. The actuator according to claim 2, wherein the opposite faces of each tooth of the spur gear includes first and second faces inclined at substantially the same inclined angles as and parallel with the first and second faces, respectively, of each tooth of the worm gear.

4. The actuator according to claim 3, wherein when the air flaps rotate to be closed in a manual operation, the first faces of the teeth of the worm gear and the spur gear come into contact with each other, preventing the air flaps from closing.

5. An actuator for an active air flap apparatus, the actuator comprising:
a worm gear driven by the power of a motor;
a spur gear configured to transmit rotary force of the worm gear towards air flaps,
wherein the worm gear has a plurality of teeth each having opposite faces symmetrically inclined at an inclined angle relative to an axially longitudinal direction of the worm gear,
wherein the spur gear has a plurality of teeth engaged with the teeth of the worm gear and each having opposite faces symmetrically inclined at substantially the same inclined angle as that of the worm gear, relative to a tangential direction of the spur gear, and
a stopper disposed in an actuator housing and configured to restrict the worm gear from moving in one direction.

6. The actuator according to claim 5, wherein when the air flaps are actuated close in a manual operation, the stopper is configured to be brought into contact with the worm gear to prevent the worm gear from moving in one direction.
